(19) United States
(12) Patent Application Publication
(10) Pub. No.: US 2019/0064365 A1
(43) Pub. Date: Feb. 28, 2019

(54) TRACKABLE LOCKING SAFE

(71) Applicant: Larry Dean, Indianapolis, IN (US)

(72) Inventor: Larry Dean, Indianapolis, IN (US)

(21) Appl. No.: 15/687,510

(22) Filed: Aug. 27, 2017

(51) Int. Cl. G01S 19/16; E05G 1/10

(52) U.S. Cl. CPC G01S 19/16; E05G 1/10

(57) ABSTRACT

A trackable locking safe includes a locking safe, and a tracking system incorporated within the locking safe and configured to transmit a tracking signal in response to an unauthorized movement of the locking safe. The tracking system includes a GPS receiver and an antenna configured to receive the GPS signals and produce and transmit the tracking signal to an authorized user to provide the three-dimensional position of the locking safe on planet earth.

### BACKGROUND OF THE INVENTION

### 1. Field of the Invention

The present general inventive concept relates generally to safe security and, more particularly, to a trackable locking safe.

### 2. Description of the Related Art

Safes are used to secure cash and valuables of all kinds. However, the method of protection currently offered consists of requiring the insertion of a pre-set code, backed up sometimes by the use of either a finger print, palm print or an eye scan. All of these precautions can be easily overcome if the thief physically removes the safe and takes it to a location where he can get it open with power tools or a blow torch.

Therefore, there is a need for an innovation that will provide a secure backup response that will foil the efforts of the thief that has overcome all of the aforementioned conventional precautions.

### SUMMARY

The present general inventive concept provides a trackable locking safe.

Additional features and utilities of the present general inventive concept will be set forth in part in the description which follows and, in part, will be obvious from the description, or may be learned by practice of the general inventive concept.

The foregoing and/or other features ad utilities of the present general inventive concept may be achieved by providing a trackable locking safe, including a locking safe and a tracking system incorporated within the locking safe and configured to transmit a tracking signal in response to unauthorized movement of the locking safe.

The tracking system may be electronically configured to detect the unauthorized movement of the locking safe and in response thereto automatically send the tracking signal originating from inside the locking safe that is receivable by the authorized user to enable the authorized user to track the movement of the locking safe and thereby have sufficient time to take actions needed to recover the locking safe.

The tracking system may include a receiver and an antenna configured to receive GPS signals from one or more satellites of a Global Positioning System (GPS) wherein the GPS signals contain information tracking and providing a three-dimensional position of the GPS receiver on planet earth.

The tracking system may include a GPS receiver and an antenna configured to receive the GPS signals and produce and transmit the tracking signal to an authorized user to provide the three-dimensional position of the locking safe on the planet earth.

The tracking system may be connected to a third party security service to dispatch police to a location of the trackable locking safe based on the tracking signal.

The tracking system may be connected to a mobile application running on a mobile device, such that a user may monitor movement and a location of the trackable locking safe on a display screen of the mobile device based on the tracking signal.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating a trackable locking safe, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

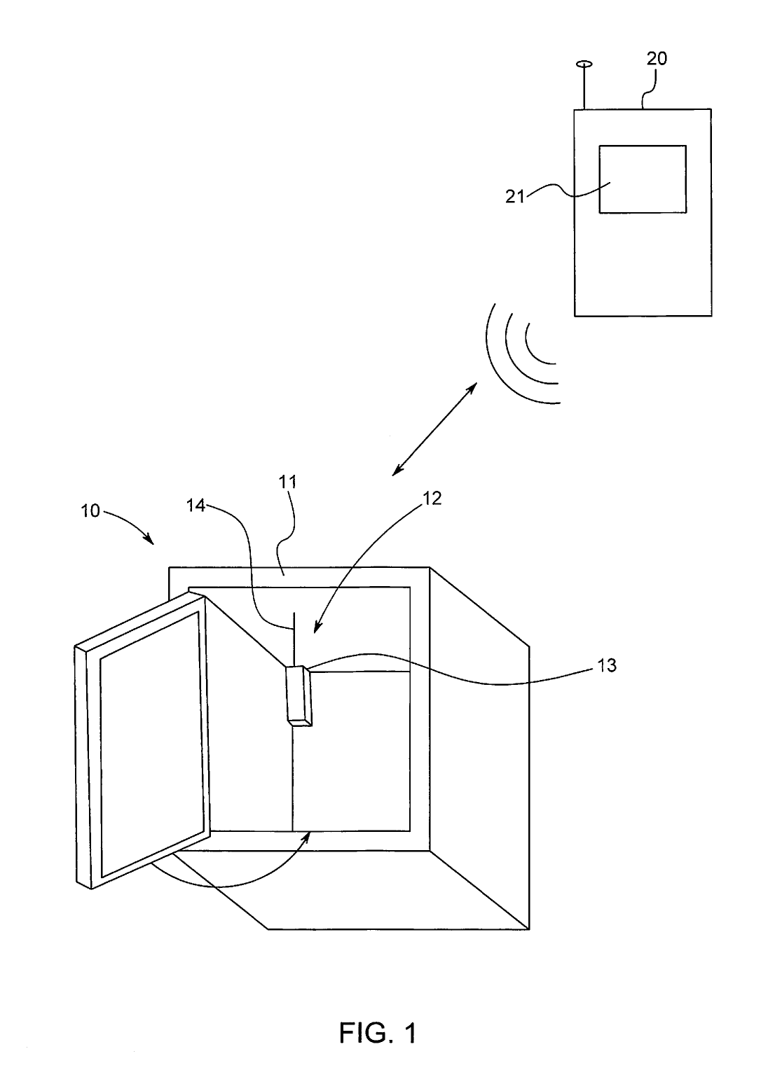

FIG. 1 is a view illustrating a trackable locking safe 10, according to an exemplary embodiment of the present general inventive concept.

Referring to FIG, 1, the trackable locking safe 10 includes a locking safe 11 and a tracking system 12 incorporated within the locking safe 11 and configured to transmit a tracking signal in response to unauthorized movement of the locking safe 11. The tracking system 12 is electronically configured to sense and detect an unauthorized movement of the locking safe 11. In response to the unauthorized movement of the locking safe 11, the tracking system 12 also is electronically configured to send automatically a tracking signal that is receivable by an authorized user of the tracking system 12. The receipt of the tracking signal will enable the authorized user to have sufficient time to track the movement of the locking safe 11 and recover the locking safe. The authorized user may be the owner of the locking safe and additional other parties, such as police departments.

The tracking system 12 may include a receiver 13 and an antenna 14 configured to receive signals from one or more satellites of a Global Positioning System (GPS). The GPS is a U.S. owned utility having a user segment that provides a user, having a GPS receiver, with GPS signals containing information tracking and providing the three-dimensional position of the GPS receiver. The receiver 13 may be a GPS receiver and the antenna 14 may receive the GPS signals from the satellites and produce and transmit the tracking signal to an authorized user on a continuing basis so as to provide the three-dimensional position of the locking safe 11 on the planet.

Thus, the tracking system 12 of the trackable locking safe 10 raises the level of protection offered by existing safes by implementing a GPS tracking system 12 built into the locking safe 11. In the event that an unauthorized person attempts to open the trackable locking safe 10 or attempts to remove it from its established location, the built in GPS tracking system will immediately alert the authorized user, such as the owner and the police, thereby allowing them to track the trackable locking safe 10 and take all needed actions to recover it.

The tracking system 12 may also include motion detectors, heat detectors, and other types of sensors that may more precisely monitor movement of the trackable locking safe 10.

Furthermore, the tracking system 14 may be connected wirelessly (or wired) to a third party security service that may monitor the trackable locking safe 10, in order to provide a police response or alternative response to a situation where there is unusual activity detected by the tracking system 12. In other words, if the trackable locking safe 10 begins to move, the tracking system 12 may detect the movement and location of the trackable locking safe 10, so that the third party security service may dispatch police to the location of the trackable locking safe 10.

Alternatively, the tracking system 12 may be connected wirelessly (or wired) to a downloadable mobile application and/or program running on a mobile device 20, the mobile application and/or program having capabilities of tracking an object using GPS technology. In other words, the tracking system 12 may communicate with the mobile device 20 using wireless technology, such that information may be transmitted therebetween. Therefore, when the trackable locking safe 10 is in motion, a user may monitor movement and a location of the trackable locking safe 10 on a display screen 21 of the mobile device 20. The mobile device 20 may include a computer, a tablet computer, a laptop computer, a cellular telephone, a smart phone, or any other mobile device known to one of ordinary skill in the art.

In view of the foregoing description, it will be readily understood that the locking safe 11, by incorporating the tracking system 12 (GPS receiver 13 and antenna 14) within the locking safe 11 is uniquely designed to enable the tracking and recovery of the locking safe 11 after it has bean physically removed from its rightful location. The GPS receiver 13 and antenna 14 by being locked within the locking safe 11, ensures that they cannot be removed by a thief prior to the locking safe 11 being opened.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A trackable locking safe, comprising:
a locking safe; and
a tracking system incorporated within the locking safe and configured to transmit a tracking signal in response to an unauthorized movement of the locking safe, wherein the tracking signal is also transmitted in response to an attempted unauthorized access of the locking safe.

2. The trackable locking safe of claim 1, wherein the tracking system is electronically configured to detect the unauthorized movement of the locking safe and in response thereto automatically send the tracking signal originating from inside the locking safe to an authorized user so as to enable the authorized user to track the movement of the locking safe and thereby provide sufficient time to take actions needed to recover the locking safe.

3. The trackable locking safe of claim 1, wherein the tracking system includes a Global Positioning System (GPS) receiver and an antenna configured to receive GPS signals from one or more satellites of a GPS wherein the GPS signals contain information tracking and providing a three-dimensional position of the GPS receiver on planet earth.

4. The trackable locking safe of claim 3, wherein the tracking system includes the GPS receiver and the antenna configured to receive the GPS signals and produce and transmit the tracking signal to an authorized user to provide the three-dimensional position of the locking safe on the planet earth.

5. The trackable locking safe of claim 1, wherein the tracking system is connected to a third party security service to dispatch police to a location of the trackable locking safe based on the tracking signal.

6. The trackable locking safe of claim 1, wherein the tracking system is connected to a mobile application running on a mobile device, such that a user may monitor movement and a location of the trackable locking safe on a display screen of the mobile device based on the tracking signal.
